(19) United States
(12) Patent Application Publication
(10) Pub. No.: US 2018/0274628 A1
(43) Pub. Date: Sep. 27, 2018

(54) Method and Device for Splicing a Conveyor Belt

(71) Applicant: Hendrick August Frederik Wilhelm Pieterse, Benoni (ZA)

(72) Inventor: Hendrick August Frederik Wilhelm Pieterse, Benoni (ZA)

(21) Appl. No.: 15/756,380

(22) PCT Filed: Sep. 28, 2016
(86) PCT No.: PCT/ZA2016/000028

§ 371 Date: Feb. 28, 2018

(30) Foreign Application Priority Data
Oct. 1, 2015 (ZA) 2015/07305

(51) Int. Cl. F16G 3/08; F16B 25/00; F16B 43/00

(52) U.S. Cl. CPC F16G 3/08; F16B 43/00; F16B 25/0015

(57) ABSTRACT

THIS invention relates to a method and device for splicing a conveyor belt. More specifically, the invention relates to a mechanical splicing device and a method of installing such splice device onto one or more lengths (10, 12) of belting to form a conveyor belt for conveying material. The device includes at least one first clamping plate (60), at one second clamping plate (80) and a plurality of self-drilling bolts (200). The first clamping plate (60) is made from a flexible polymeric material having a plurality of washers (68) each located on the first clamping plate (60) such that a hole (92) defined by a respective washer (68) is aligned with one of a plurality of holes (92) defined in the first clamping plate (60). The second clamping plate (80) is made from a flexible polymeric material and have a plurality of nuts (88), each located on the second clamping plate (80) such that a threaded hole (90) defined by a respective nut (88) is aligned with one of a plurality of holes (92) defined In the second clamping plate (80). The self-drilling bolts (200) are sized and shaped to pass through the holes (72) defined by the first clamping plate (60) and washers (68) located thereon, and to threadably engage the threaded holes (90) of the nuts (88) located on the second clamping plate (80). In use, with overlapping ends of belting lengths (10, 12) to be spliced sandwiched between the first and second clamping plates (60, 80), the self-drilling bolts (200) are drillable through the first clamping plate (60), through the overlapping belting ends (14,16) and into threaded engagement with aligned holes in the second clamping plate (80) thereby to damp the overlapping belting ends (14,16) between the first and second damping plates so as to splice such ends to one another.

### BACKGROUND OF THE INVENTION

THIS invention relates to a method and device for splicing a conveyor belt. More specifically, the invention relates to a mechanical splicing device and a method of installing such splice device onto one or more lengths of belting to form a conveyor belt for conveying material.

There are generally two types of splicing process that are well known. One is a vulcanisation process, consisting of hot and cold splicing, and the other is a mechanical process or splice.

Hot splicing requires the splice to be heated and cured under pressure with a vulcanising press. It will be appreciated that where conveyor belts need to be refurbished in-situ, such vulcanising press and other specialty tools need to be transported to required the location, which in remote areas, is most cumbersome.

Cold splicing, instead of making use of a vulcanising press, uses a bonding agent that causes a chemical reaction to splice the belt ends together. Both hot splicing and cold splicing vulcanisation require highly skilled and trained experts having a thorough knowledge of solvents, bonding materials and the like.

Both vulcanization processes also require specific temperate, compression and dwell time, as well as a near moisture free work environment. Both processes may also not be suited to some belts, particularly those that are old, dirty or unevenly worn.

Another disadvantage of vulcanisation processes is the downtime required for the splice to cure properly, which is typically between 6 and 11 hours, if not more depending on the working conditions and size of the splice required. Furthermore, it is well known that vulcanisation processes are expensive both from labour and downtime points of view.

The speed and simplicity of mechanical splice installation represents major advantages over the vulcanisation processes. Depending on belt width and thickness, most mechanical splices can be finished in less than one hour and are installed by an in house crew with portable, easy-to-use installation tools. Additionally, mechanical splices can be made in restrictive environments, with no special regard for space, temperature, moisture or contaminants.

Mechanical splicing also offers reduced belt waste and visibility of splice conditions, which enables a worn splice to be taken care of before a complete belt failure, which does not happen with vulcanised splices.

Although it is arguable that by countersinking mechanical splices such that their fastener plates are flush with the belt's cover eliminates any interference with tight-fitting scrapers, skirtboards, and other conveyor components, it is well known that these problems still persist in practice, with long lengths of belt being stripped due to such interference.

Furthermore, it generally accepted in practice that mechanical splices do not ride over pulleys as efficiently as their vulcanised splice counterparts, and are typically weaker.

It is an object of the present invention to provide a mechanical splicing device and method of installing such device that addresses the disadvantages of the known vulcanisation and mechanical splicing process.

For the purposes of describing the present invention, any reference to:
angles being “substantially the same”;
surfaces, edges or other parts being “substantially aligned, parallel or flush”; and
angles being between “about” a specified range;

will be taken to respectively mean the same angle, aligned, parallel, flush or such specified range of angles and/or any variance of up to 10 degrees therefrom.

### SUMMARY OF THE INVENTION

According to a first aspect of the invention there is provided a method for splicing one or more lengths of belting to form a conveyor belt for conveying material, wherein the belting comprises (i) opposing first and second surfaces on opposing first and second sides of the belting and spaced from one another across a thickness of the belting and (ii) opposing first and second lateral edges spaced from one another across a width of the belting, the method including the steps of:

(A) cutting a belting length across its width to define a first splice end, the first splice end being angled relative to the first lateral edge of its belting length by a predetermined splice angle;

(B) cutting the same or a different belting length across its width to define a second splice end, the second splice end being angled relative to the second lateral edge of its belting length by substantially the same predetermined splice angle such that, with the first and second lateral edges and the first and second surfaces of belting lengths to be spliced respectively and substantially aligned, the first and second splice ends are substantially parallel;

(C) stripping away one or more layers of the belting near the first splice end thereof to respectively define a first splice rebate on the first side of the belting and a first mating rebate on the second side of the belting, the first rebates each defining one or more treads and one or more risers, wherein the risers are substantially parallel with the first splice end such that the treads are parallelepiped;

(D) stripping away one or more layers of the belting near the second splice end thereof to respectively define a second splice rebate on the second side of the belting and a second mating rebate on the first side of the belting, the second rebates each defining one or more treads and one or more risers, wherein the risers are substantially parallel with the second splice end such that the treads are parallelepiped;

(E) overlapping the first and second splice ends of the belting such that with the first and second lateral edges and the first and second surfaces of the belting lengths to be spliced respectively and substantially aligned, the first and second mating rebates lie one over the other, with the first and second splice rebates located one over the other on opposite sides of the belting and in a substantially aligned condition relative to one another;

(F) placing first clamping plates into the first splice rebate defined on the first side of the belting and second clamping plates into the second splice rebate defined on the second side of the belting such that the first and the second clamping plates are located one over the other on opposite sides of the belting, with outer surfaces thereof substantially flush with the respective first and second surfaces of the belting;

(G) aligning at least one lateral edge of the first and the second clamping plates with one of the lateral edges of the belting thereby to align a plurality of holes defined in the first clamping plates with a plurality of holes defined in the second clamping plates; and

(H) passing fasteners through each of the holes in the first clamping plates, through the overlapping first and second splice ends of the belting and into threaded engagement with the aligned holes in the second clamping plates thereby to clamp the overlapping first and second splice ends of the belting between the first and second clamping plates so as to splice such ends to one another.

Generally, the predetermined splice angle is an acute angle defined between one of the respective first and second splice ends and one of the lateral edges of the belting and between about 60 and 70 degrees.

Typically, the layers stripped from the belting are one or more plies making up the thickness of the belting.

Preferably, the first splice end and the second splice end are operatively respective leading and trailing ends of a conveyor belt relative to an intended direction of travel of the conveyor belt, the first mating rebate of the first splice end operatively overlying the second mating rebate of the second splice end such that the first and second surfaces of the belting are operative upper and lower surfaces thereof.

The corresponding first and second mating rebates may each comprise a plurality of stepped formations, with the stepped formations of the first mating rebate stepping outwardly across the thickness of the belting from a location near its centre of thickness towards the second surface of the belting, and with the stepped formations of the second mating rebate stepping outwardly across the thickness of the belting from a location near its centre of thickness towards the first surface of the belting.

Generally, the depth of the first and second splice rebates is substantially the same as a thickness of the respective first and second clamping plates, wherein:
the first clamping plates are flexible and have a plurality of washers, each located on the flexible first clamping plates such that a hole defined by a respective washer is aligned with one of the holes defined in the flexible first clamping plates; and
the second clamping plates are flexible and have a plurality of nuts, each located on the flexible second clamping plates such that a threaded hole defined by a respective nut is aligned with one of the holes defined in the flexible second clamping plates.

Typically, the flexible first and second clamping plates are made from a polymeric material with the washers and nuts encased within the respective flexible polymeric first and second clamping plates.

Preferably, the first and second clamping plates are parallelepiped and shaped to fit within the first and second splice rebates.

Where multiple first and second clamping plates are required across the width of belting lengths to be spliced, an alignment tool is preferably engageable with such first and/or second clamping plates to correctly align and space adjacent clamping plates relative to one another.

Generally, the alignment tool comprises a plurality of pins extending outwardly from a spine thereof, which pins are sized and spaced relative to one another to engage at least two holes in each of the adjacent clamping plates.

The passing of the fasteners through the clamping plates and the belting is typically done by drilling self-drilling bolt fasteners there through, the self-drilling bolt fasteners having a length substantially the same as or smaller than the thickness of the belting. It will be appreciated that over and above the method steps set out above, other method steps common to the steps that are typically undertaken for installing existing mechanical splices may need to be employed. These steps, amongst others, include:
selecting a suitable location for installing the splice, which location is preferably a flat and horizontal portion of the conveyor belt system;
adjusting the take-up of the conveyor belt system to its minimum position;
bringing the portion of the conveyor belt requiring replacement and splicing into the selected location and ensuring that sufficient length is available for overlapping the belt ends to be spliced;
tensioning and lashing the belt ends to be spliced to the conveyor belt structure; and
rolling out the new belt length between the first and second splice ends.

According to a second aspect of the invention, there is provided a device for splicing one or more lengths of belting to form a conveyor belt for conveying material including:
at least one first clamping plate made from a flexible polymeric material and having a plurality of washers, each located on the first clamping plate such that a hole defined by a respective washer is aligned with one of a plurality of holes defined in the first clamping plate;
at least one second clamping plate made from a flexible polymeric material and have a plurality of nuts, each located on the second clamping plate such that a threaded hole defined by a respective nut is aligned with one of a plurality of holes defined in the second clamping plate; and
a plurality of self-drilling bolts sized and shaped to pass through the holes defined by the first clamping plate and washers located thereon, and to threadably engage the threaded holes of the nuts located on the second clamping plate;
such that in use, with overlapping ends of belting lengths to be spliced sandwiched between the first and second clamping plates, the self-drilling bolts are drillable through the first clamping plate, through the overlapping belting ends and into threaded engagement with aligned holes in the second clamping plate thereby to clamp the overlapping belting ends between the first and second clamping plates so as to splice such ends to one another.

Generally, the washers and nuts are encased within the respective first and second clamping plates.

Typically, the first and second clamping plates are parallelepiped having a pair of opposing and parallel primary sides and a pair of opposing and parallel secondary sides, and further wherein an acute angle defined between adjacent primary and secondary sides is between about 60 and 70 degrees.

Preferably, the first and second clamping plates are elongate, the primary sides thereof being major sides with the secondary sides thereof being minor sides.

Each of the first and second clamping plates may have a substantially flat contact surface for contacting the belting during a splicing operation and an opposing operatively facing outward surface, the peripheries of which are chamfered or rounded.

Most preferably, the self-drilling bolts have a length substantially the same as or smaller than the thickness of the belting to be spliced.

It will be appreciated that the device may further include an alignment tool for correctly aligning and spacing a plurality of adjacent clamping plates relative to one another, the alignment tool having a plurality of pins extending outwardly from a spine thereof, which pins are sized and spaced relative to one another to engage at least two holes in each of the adjacent clamping plates.

### BRIEF DESCRIPTION OF THE DRAWINGS

The invention will now be described in more detail, by way of example only, with reference to the accompanying drawings in which:

FIGS. 1 is a perspective view of belting lengths to be spliced with a mechanical splice device in accordance with the present invention and in accordance with a method of installation described herein;

FIG. 2 is a perspective view of the belting lengths of FIG. 1 in an overlapping condition with the clamping plates and self-drilling bolts of the mechanical splice device exploded therefrom;

FIG. 3 is a perspective view of the belting lengths of FIG. 1 in an overlapping mating condition with the clamping plates of the mechanical splice device exploded therefrom;

FIG. 4A&B are perspective views of the first and the second clamping plates showing the respective washers and nuts encased therein;

FIG. 5 is a perspective view of the belting lengths of FIG. 1 in an overlapping mating condition with the clamping plates assembled there onto and with self-drilling bolts being drilled there through; and

FIG. 6 is a perspective view of the belting lengths of FIG. 1 clamped between the clamping plates in a spliced condition

### DETAILED DESCRIPTION OF THE DRAWINGS

A method for mechanically splicing one or more lengths of belting to form a conveyor belt for conveying material, according to a first aspect of the invention, is described generally in the accompanying figures.

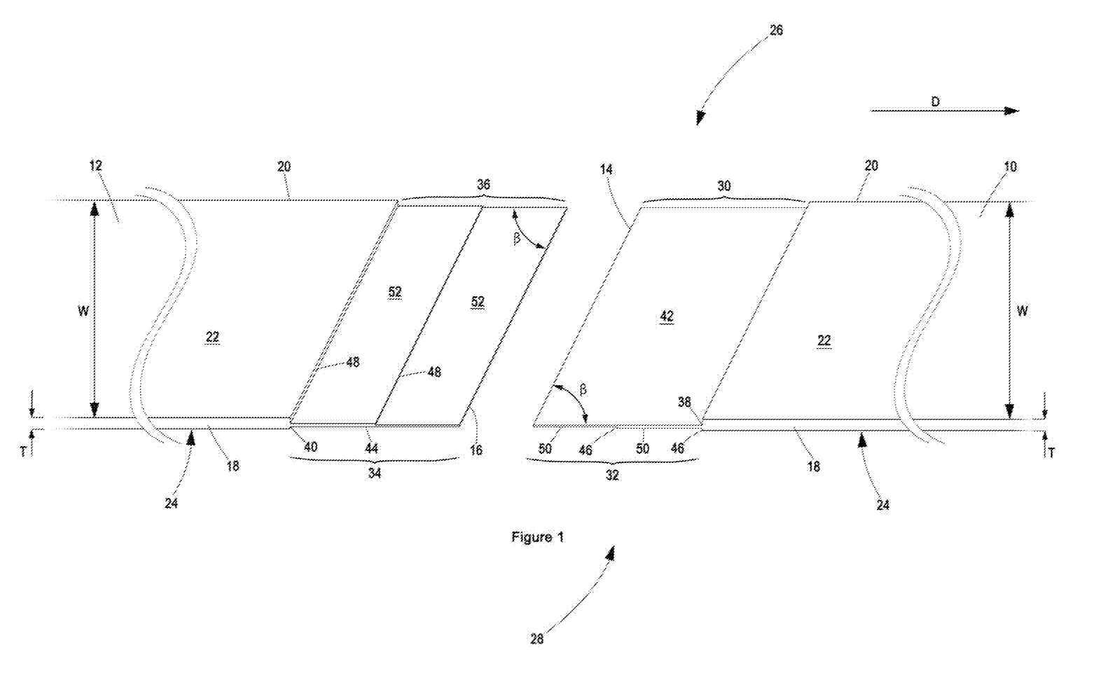

FIG. 1 depicts first and second belting lengths 10, 12 of a single belt having ends to be spliced, or of different belts having ends to be spliced.

A first splice end 14 is defined by cutting the first belting length 10 at a predetermined angle across a width “W” thereof, such that the predetermined angle “β” as measured between the first splice end 14 and a first lateral edge 18 of the first belting length 10 is between about 60 and 70 degrees.

Similarly, a second splice end 16 is defined by cutting the second belting length 12 at the same or substantially similar predetermined angle across the width “W” thereof, where such predetermined angle “β” lies between the second splice end 16 and an opposing second lateral edge 20 of the second belting length 12, where the first and second lateral edges 18, 20 are spaced from one another across the width “W” of the belting lengths 10, 12.

In this manner, it will be appreciated that with the first and the second lateral edges 18, 20, as well as the first and second surfaces 22, 24 on opposite first and second sides 26, 28 of the belting lengths 10, 12 respectively and substantially aligned, the first and second splice ends 14, 16 are substantially parallel. It will be appreciated further that the first and second surfaces 22, 24 are respective operative upper and lower surfaces of the belting lengths 10, 12 and spaced apart from one across a thickness “T”: of such belting lengths 10, 12.

The next step in the method involves stripping away one or more layers or plies of the belting lengths 10, 12 near each of the first and second splice ends 14, 16 thereby to define:
a first splice rebate 30 on the first side 26 of the first belting length 10;
a first mating rebate 32 on the second side 28 of the belting length 10;
a second splice rebate 34 on the second side 28 of the second belting length 12; and
a second mating rebate 36 on the first side 26 of the belting length 12.

The first and second splice rebates 30, 34 each define at least one respective riser 38, 40 being parallel with the respective first and second splice ends 14, 16 such that at least one respective treads 42, 44 of the first and second splice rebates 30, 34 are parallelepiped.

Although not essential, it is preferable that the first and second mating rebates 32, 36 each define a plurality of stepped formations defining a plurality of respective risers 46, 48 being parallel with the respective first and second splice ends 14, 16 such that each of a plurality of respective treads 50, 52 thereof are parallelepiped.

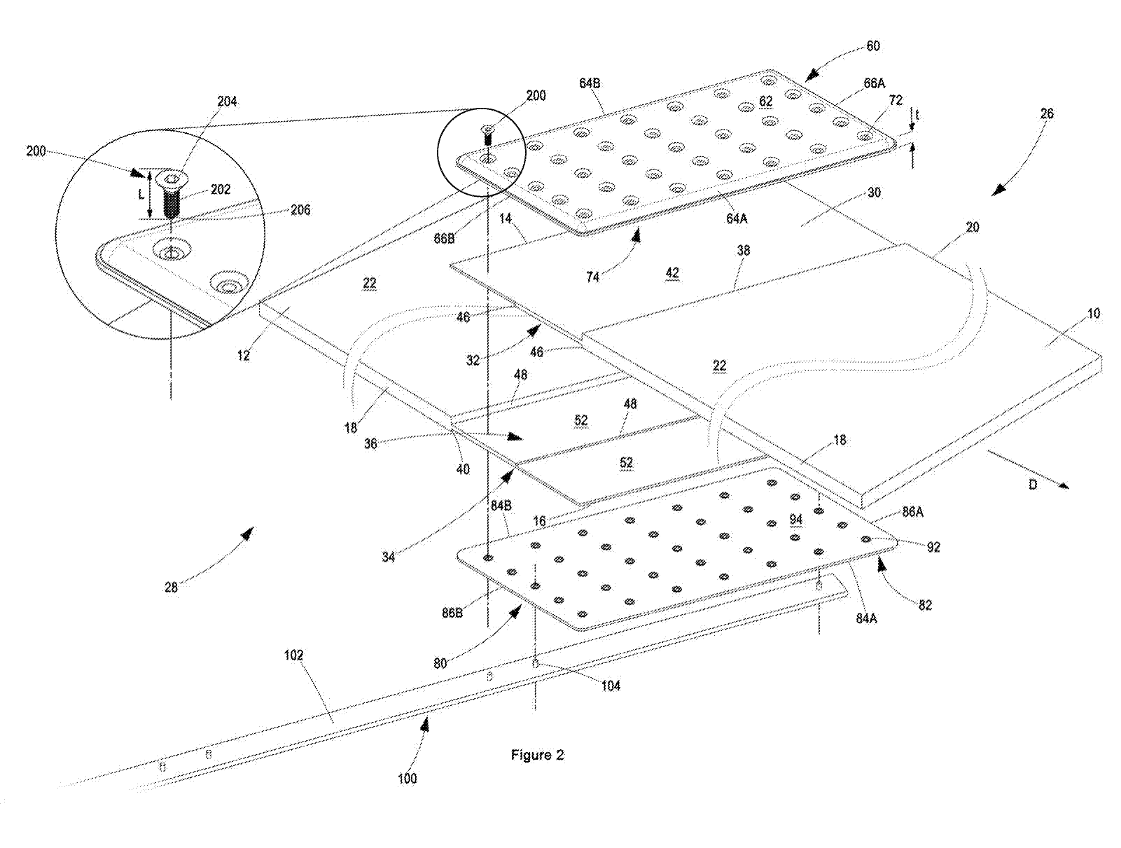

With reference now also to FIG. 2, and to enable the first and second mating surfaces to mate correctly when brought into an overlapping configuration, the stepped formations of the first mating rebate 32 are defined on the second side 28 of the belting lengths 10 12 with the stepped formations of the second mating rebate 36 defined on the first side 26 of the belting lengths 10 12.

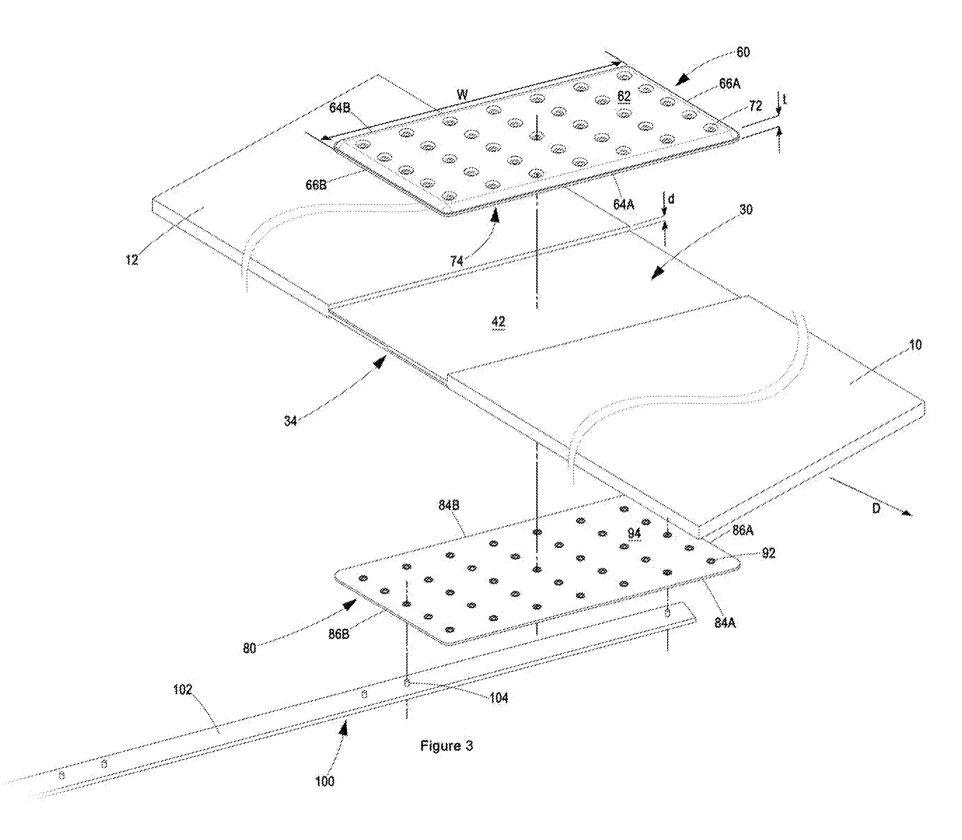

FIG. 3 depicts the first and second splice ends 14, 16 in an overlapping mated configuration, with the first stepped mating rebate 32 overlying and in engagement with the second stepped mating rebate 36. In this overlapping mated configuration, the first and second splice rebates 30, 34 are located one over the other on opposite sides 26, 28 of the belting lengths 10, 12 and in a substantially aligned condition relative to one another.

In this condition, and will reference still to FIGS. 2 and 3, first clamping plates 60 and second clamping plates 80 are capable of being placed within the respective first and second splice rebates 30, 34 such that the first and the second clamping plates 60, 80 are located one over the other on the opposite sides 26, 28 of the belting lengths 10, 12.

It will be appreciated that first and second splice rebates 30, 34 have a depth “d” substantially the same as the thickness “t” of the clamping plates 60, 80. In this manner, the clamping plates 60, 80 are countersunk into the belting lengths 10, 12 so that operatively outer surfaces 62, 82 of the clamping plates 60, 80 are substantially flush with the respective first and second surfaces 22, 24 of the belting lengths 10, 12 once spliced.

The first and second clamping plates 60, 80 form part of the mechanical splice device, with each of such clamping plates 60, 80 comprising a parallelepiped shape having a pair of opposing primary major sides 64A, 64B; 84A, 84B and a pair of opposing secondary minor sides 66A, 66B; 86A, 86B.

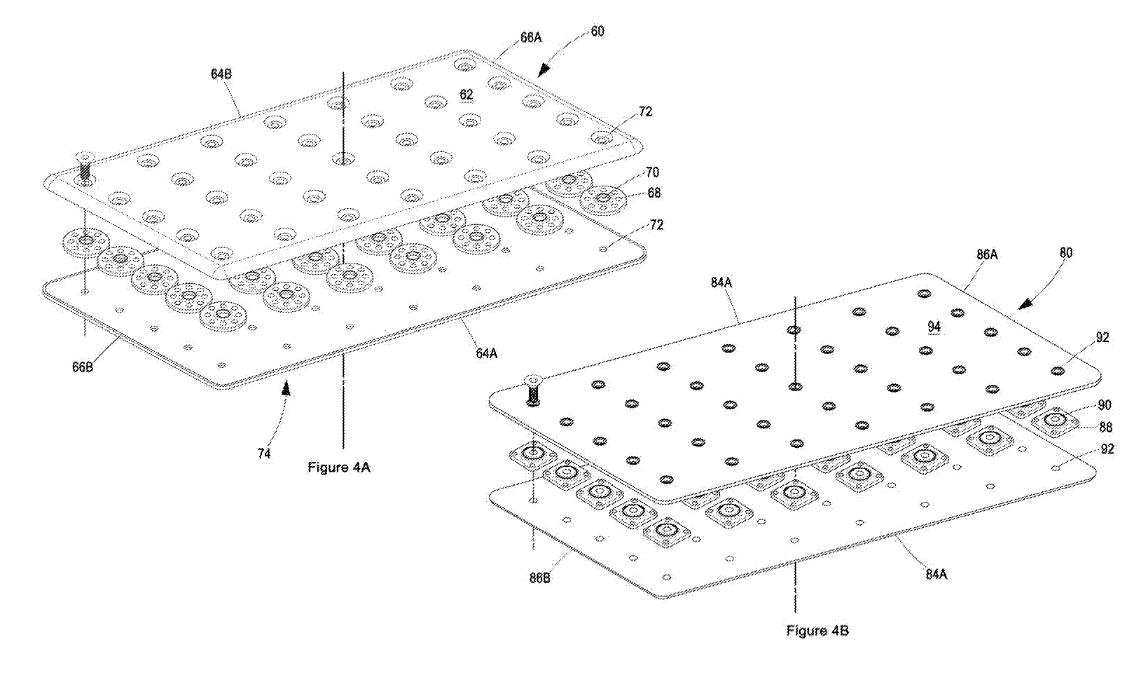

Furthermore, and with reference now to FIG. 4A, the first clamping plate 60 is typically made of a flexible polymeric material having encased therein a plurality of washers 68 defining a hole 70 therein aligned with one of a plurality of holes 72 defined in the first clamping plate 60.

Similarly, and with reference now to FIG. 4B, the second clamping plate 80 is typically also made of a flexible polymeric material having encased therein a plurality of nuts 88 defining a threaded hole 90 therein aligned with one of a plurality of holes 92 defined in the second clamping plate 60.

With reference to FIGS. 2, 3 and 5, and with the first and second clamping plates 60, 80 received in the respective first and second splice rebates 30, 34, at least one of the minor sides 66A, 86A of each of the clamping plates 60, 80 are alignable with the respective second lateral edge 20 of the belting lengths 10, 12 thereby to align the holes 72 in the first clamping plate 60 with the holes 92 in the second clamping plate 80.

Where the width “W” of the belting lengths 10, 12 is wider than a width “w” of the clamping plates 60, 80, it will be appreciated that a plurality of adjacently configured clamping plates 60, 80 may be placed into each of the respective first and second splice rebates 30, 34. The mechanical splice device may further include an alignment tool 100 having a spline 102 and a plurality of pins 104 sized and spaced relative to one another to engage with at least two holes 92 of each of a plurality of adjacently position second clamping plates 80.

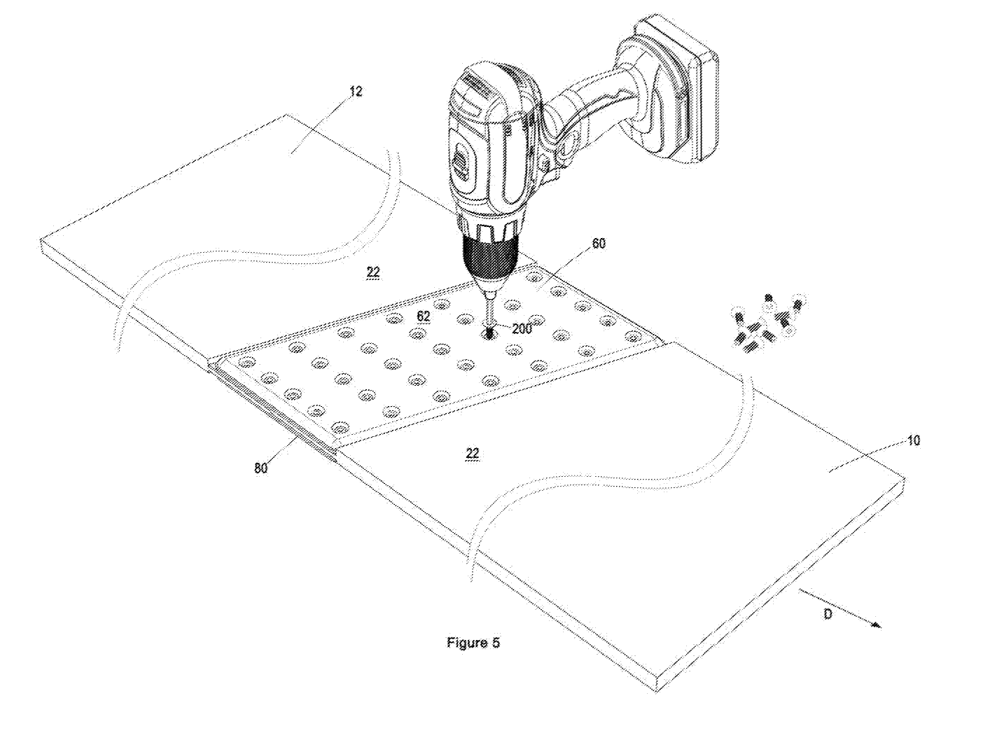

With the holes 72, 92 of the first and second clamping plates 60, 80 aligned, and as illustrated in FIG. 5, self-drilling bolts 200 can be drilled into each of the holes 72 of the first clamping plate 60. With reference also to FIG. 2, the self-drilling bolts 200 have a threaded shank 202 with a head 204 and a cutting tip 206 at opposite ends of its length “L”, which is preferably no longer than the thickness “T” of the belting lengths 10, 12

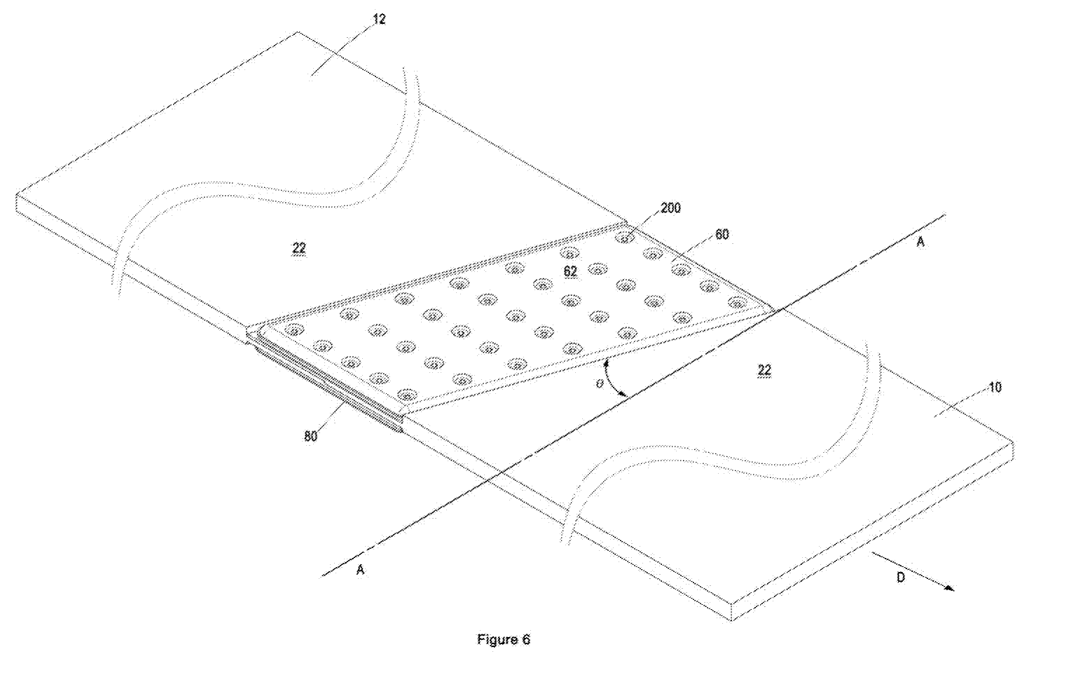

As the self-drilling bolts are drilled into the holes 72 of the first clamping plate 60, the cutting tip 206 thereof drills through the overlapping ends 14, 16 of the belting lengths 10, 12 to come into threaded engagement with the holes 92 of the second clamping plates 80. In this manner, the overlapping ends 14, 16 are clamped between the first and second clamping plates 60, 80 consequently splicing the belting lengths 10, 12 to one another as illustrated in FIG. 6.

It will be appreciated that for the first and second clamping plates 60, 80 to fit into the first and second splice rebates 30, 34 and align with the respective lateral edge 18, 20 of the belting lengths 10, 12, the first and second clamping plates 60, 80 must have at least an acute angle between adjacent major and minor sides 64A, 66A; 84A, 86A the same or substantially similar to the predetermined angle “β”.

Furthermore, each of the first and second clamping plates 60, 80 have a respective and substantially flat contact surface 74, 94, opposing the operatively outer surfaces 62, 82 thereof, for the belting lengths 10, 12 during the splicing operation.

Preferably, the operatively outer surfaces 62, 82 of the first and second clamping plates 60, 80 have chamfered or rounded peripheries.

It will be appreciated that with the first and second clamping plates 60, 80 having leading edges 64A, 84A angled at an angle θ of between 20 and 30 degrees to a datum line A-A passing perpendicularly across the intended direction of travel “D”, together with the chamfered or rounded peripheries thereof, interference between the mechanical splice device in accordance with this invention and tight-fitting scrapers, skirtboards, and other conveyor components is highly unlikely.

The advantages of the method and device described herein are envisaged to be:
minimal tension acting on the splice device when passing over a pulley due to anchorage of the bolts into a carcass of the conveyor belt;
increased flexibility for efficiently riding over pulleys;
a 3 mm thickness of polymer material (typically rubber) beyond each of the ends of the self-drilling bolts;
minimal gap propagation and stretching due to overlapping spliced ends;
greater clamping surface due ton encased washers and nuts;
reusability by simply unbolting the self-drilling bolts from the clamping plates;
one size fits all clamping plates that are positionable adjacent one another for larger sized splices; and
clamping plates can be cut to size by hand on site.

Although the invention has been described above with reference to a preferred method and embodiment, it will be appreciated that many modifications or variations of the invention are possible without departing from the spirit or scope of the invention.

For example, multiple clamping plates may not only be positioned adjacently across the width of the belting lengths but also adjacently lengthwise along the conveyor belt in multiple rows.

Furthermore an adhesive may be utilised between the overlapping ends 14, 16 and/or the clamping plates to better splice the belting lengths to one another.

1. A method for splicing one or more lengths of belting to form a conveyor belt for conveying material, wherein the belting comprises (i) opposing first and second surfaces on opposing first and second sides of the belting and spaced from one another across a thickness of the belting and (ii) opposing first and second lateral edges spaced from one another across a width of the belting, the method including the steps of:
(A) cutting a belting length across its width to define a first splice end, the first splice end being angled relative to the first lateral edge of its belting length by a predetermined splice angle;
(B) cutting the same or a different belting length across its width to define a second splice end, the second splice end being angled relative to the second lateral edge of its belting length by substantially the same predetermined splice angle such that, with the first and second lateral edges and the first and second surfaces of belting lengths to be spliced respectively and substantially aligned, the first and second splice ends are substantially parallel;
(C) stripping away one or more layers of the belting near the first splice end thereof to respectively define a first splice rebate on the first side of the belting and a first mating rebate on the second side of the belting, the first rebates each defining one or more treads and one or more risers, wherein the risers are substantially parallel with the first splice end such that the treads are parallelepiped;
(D) stripping away one or more layers of the belting near the second splice end thereof to respectively define a second splice rebate on the second side of the belting and a second mating rebate on the first side of the belting, the second rebates each defining one or more treads and one or more risers, wherein the risers are substantially parallel with the second splice end such that the treads are parallelepiped;
(E) overlapping the first and second splice ends of the belting such that with the first and second lateral edges and the first and second surfaces of the belting lengths to be spliced respectively and substantially aligned, the first and second mating rebates lie one over the other, with the first and second splice rebates located one over the other on opposite sides of the belting and in a substantially aligned condition relative to one another;
(F) placing first clamping plates into the first splice rebate defined on the first side of the belting and second clamping plates into the second splice rebate defined on the second side of the belting such that the first and the second clamping plates are located one over the other on opposite sides of the belting, with outer surfaces thereof substantially flush with the respective first and second surfaces of the belting;
(G) aligning at least one lateral edge of the first and the second clamping plates with one of the lateral edges of the belting thereby to align a plurality of holes defined in the first clamping plates with a plurality of holes defined in the second clamping plates; and
(H) passing fasteners through each of the holes in the first clamping plates, through the overlapping first and second splice ends of the belting and into threaded engagement with the aligned holes in the second clamping plates thereby to clamp the overlapping first and second splice ends of the belting between the first and second clamping plates so as to splice such ends to one another.

2. A method according to claim 1, wherein the predetermined splice angle is an acute angle defined between one of the respective first and second splice ends and one of the lateral edges of the belting and between about 60 and 70 degrees.

3. A method according to claim 2, wherein the layers stripped from the belting are one or more plies making up the thickness of the belting.

4. A method according to claim 3, wherein the first splice end and the second splice end are operatively respective leading and trailing ends of a conveyor belt relative to an intended direction of travel of the conveyor belt, the first mating rebate of the first splice end operatively overlying the second mating rebate of the second splice end such that the first and second surfaces of the belting are operative upper and lower surfaces thereof.

5. A method according to claim 4, wherein the corresponding first and second mating rebates each comprise a plurality of stepped formations, with the stepped formations of the first mating rebate stepping outwardly across the thickness of the belting from a location near its centre of thickness towards the second surface of the belting, and with the stepped formations of the second mating rebate stepping outwardly across the thickness of the belting from a location near its centre of thickness towards the first surface of the belting.

6. A method according to claim 5, wherein the depth of the first and second splice rebates is substantially the same as a thickness of the respective first and second clamping plates, and further wherein:
the first clamping plates are flexible and have a plurality of washers, each located on the flexible first clamping plates such that a hole defined by a respective washer is aligned with one of the holes defined in the flexible first clamping plates; and
the second clamping plates are flexible and have a plurality of nuts, each located on the flexible second clamping plates such that a threaded hole defined by a respective nut is aligned with one of the holes defined in the flexible second clamping plates.

7. A method according to claim 6, wherein the flexible first and second clamping plates are made from a polymeric material with the washers and nuts encased within the respective flexible polymeric first and second clamping plates.

8. A method according to claim 7, wherein the first and second clamping plates are parallelepiped and shaped to fit within the first and second splice rebates.

9. A method according to claim 8, wherein where multiple first and second clamping plates are required across the width of belting lengths to be spliced, an alignment tool is engageable with such first and/or second clamping plates to correctly align and space adjacent clamping plates relative to one another, the alignment tool having a plurality of pins extending outwardly from a spine thereof, which pins are sized and spaced relative to one another to engage at least two holes in each of the adjacent clamping plates.

10. A method according to claim 9, wherein the passing of the fasteners through the clamping plates and the belting is done by drilling self-drilling bolt fasteners there through, the self-drilling bolt fasteners having a length substantially the same as or smaller than the thickness of the belting.

11. A device for splicing one or more lengths of belting to form a conveyor belt for conveying material including:
at least one first clamping plate made from a flexible polymeric material and having a plurality of washers, each located on the first clamping plate such that a hole defined by a respective washer is aligned with one of a plurality of holes defined in the first clamping plate;
at least one second clamping plate made from a flexible polymeric material and have a plurality of nuts, each located on the second clamping plate such that a threaded hole defined by a respective nut is aligned with one of a plurality of holes defined in the second clamping plate; and
a plurality of self-drilling bolts sized and shaped to pass through the holes defined by the first clamping plate and washers located thereon, and to threadably engage the threaded holes of the nuts located on the second clamping plate;
such that in use, with overlapping ends of belting lengths to be spliced sandwiched between the first and second clamping plates, the self-drilling bolts are drillable through the first clamping plate, through the overlapping belting ends and into threaded engagement with aligned holes in the second clamping plate thereby to clamp the overlapping belting ends between the first and second clamping plates so as to splice such ends to one another.

12. A device according to claim 11, wherein the washers and nuts are encased within the respective first and second clamping plates.

13. A device according to claim 12, wherein the first and second clamping plates are parallelepiped having a pair of opposing and parallel primary sides and a pair of opposing and parallel secondary sides, and further wherein an acute angle defined between adjacent primary and secondary sides is between about 60 and 70 degrees.

14. A device according to claim 13, wherein the first and second clamping plates are elongate, the primary sides thereof being major sides with the secondary sides thereof being minor sides.

15. A device according to claim 14, wherein each of the first and second clamping plates have a substantially flat contact surface for contacting the belting during a splicing operation and an opposing operatively facing outward surface, the peripheries of which are chamfered or rounded.

16. A device according to claim 15, wherein the self-drilling bolts have a length substantially the same as or smaller than the thickness of the belting to be spliced.

17. A device according to claim 16 further including an alignment tool for correctly aligning and spacing a plurality of adjacent clamping plates relative to one another, the alignment tool having a plurality of pins extending outwardly from a spine thereof, which pins are sized and spaced relative to one another to engage at least two holes in each of the adjacent clamping plates.

18-19. (canceled)
